(19) United States
(12) Patent Application Publication
(10) Pub. No.: US 2010/0164694 A1
(43) Pub. Date: Jul. 1, 2010

(54) Article inventory device, article inventory system, and article inventory method

(75) Inventors: Yu Matsubara, Nagoya-shi (JP); Hiroshi Oida, Ogaki-shi (JP); Yuta Inagaki, Seto-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/584,660

(22) Filed: Sep. 10, 2009

(30) Foreign Application Priority Data
Sep. 19, 2008 (JP) 2008-240587

(51) Int. Cl. H04Q 5/22

(52) U.S. Cl. 340/10.42

(57) ABSTRACT

This disclosure discloses an article inventory device comprising: an area information obtainment portion configured to obtain inventory area information; a recording portion configured to record an article list in which registration identification information and storing area information are associated with each other; a determining portion configured to determine whether or not the registration identification information match the identification information and whether or not the storing area information match the inventory area information; a classifying portion configured to classify the article into a group of an inventory abnormal state if it is determined that at least either the identification information and the registration identification information or the inventory area information and the storing area information do not match; and a return processing portion configured to execute return processing to an inventory normal state for the article classified into the group of the inventory abnormal state.

### CROSS-REFERENCE TO RELATED APPLICATION

The present application claims priority from Japanese Patent Application No. 2008-240587, which was filed on Sep. 19, 2008, the disclosure of which is incorporated herein by reference in its entirety.

### BACKGROUND OF THE INVENTION

1. Field of the Invention

The present invention relates to an article inventory device, an article inventory system, and an article inventory method configured to make an inventory of articles as targets of inventory and particularly to an article inventory device, an article inventory system, and an article inventory method configured to make an inventory by reading identification information via radio communication from an RFID tag which is affixed to an article and in which the identification information of the article is recorded.

2. Description of the Related Art

There has been a case where a Radio Frequency Identification (RFID) tag in which an identification number of an article is recorded is affixed to the article to be placed at a predetermined place. A user can make an inventory of the article by reading identification information of the article from the RFID tag by an RFID reader.

Recently, a system configured to inspect and manage materials in a library using an RFID tag and an RFID reader has been proposed in JP, A, 2005-332332. In this system, a user sets a range of inspection such as a type of materials or arranged places to be inspected. The user specifies an inspection target range for a range of inspection to a server. A server creates an inspection DB (database) for an inspection operation on the basis of the inspection target range.

The user reads an RFID tag affixed to a material in the inspection range by an RFID reader. The server gets information read by the RFID reader and compares it with an inspection DB. Then, the server displays if the material has been lost or not, on loan, missing as the result of comparison between the information read by the RFID reader and the inspection DB as a state of the material in the inspection result.

However, with the prior art reference described in the above-described JP, A, 2005-332332, the sever displays a state of the material in the inspection result. It is configured such that the user checks the inspection result by the displayed state of the material. That is, with the prior art reference, even if the material is in an abnormal state of missing or misplacement as the result of inspection, no consideration is given to handling of an abnormal state such as return to a normal state. Therefore, there is a problem that the user is forced to select and execute the handling of the abnormal state by himself/herself.

### SUMMARY OF THE INVENTION

The present invention has an object to provide an article inventory device, an article inventory system, and an article inventory method that can take appropriate handling without forcing a burden on a user if a state of an article is abnormal as the result of inventory of the article.

### BRIEF DESCRIPTION OF THE DRAWING

FIG. 1 is an explanatory diagram illustrating an outline of an inventory of an article according to a first embodiment of the present invention.

FIG. 2 is an explanatory diagram illustrating an example of a hardware configuration of an RFID reader according to the first embodiment of the present invention.

FIG. 3 illustrates an outline of an article table before an inventory is made according to the first embodiment of the present invention.

FIG. 4 illustrates an article table after the inventory is made according to the first embodiment of the present invention.

FIG. 5 illustrates a disposal table according to the first embodiment of the present invention.

FIG. 6 is a flowchart illustrating contents of processing by the RFID reader according to the first embodiment of the present invention.

FIG. 7 is a flowchart illustrating contents of inventory processing (Step S602 shown in FIG. 6) according to the first embodiment of the present invention.

FIG. 8 is a flowchart illustrating contents of display processing of an inventory result (Step S603 shown in FIG. 6) according to the first embodiment of the present invention.

FIG. 9 is an explanatory diagram illustrating an example of an inventory result display screen according to the first embodiment of the present invention.

FIG. 10 is a flowchart illustrating contents of return processing (Step S606 shown in FIG. 6) of an undiscovered article according to the first embodiment of the present invention.

FIG. 11 is a flowchart illustrating contents of the return processing (Step S607 shown in FIG. 6) of a misplaced article according to the first embodiment of the present invention.

FIG. 12 is a flowchart illustrating contents of the return processing (Step S608 shown in FIG. 6) of an unregistered article according to the first embodiment of the present invention.

FIG. 13 is an explanatory diagram illustrating an outline of an article inventory system according to a second embodiment of the present invention.

FIG. 14 is an explanatory diagram illustrating an example of a hardware configuration of the article inventory system according to the second embodiment of the present invention.

### DETAILED DESCRIPTION OF THE PREFERRED EMBODIMENTS

A preferred embodiment of an article inventory device, an article inventory system, an article inventory method, and an article inventory program according to the present invention will be described below referring to the attached drawings.

### First Embodiment

(Outline of an Article Inventory Device)

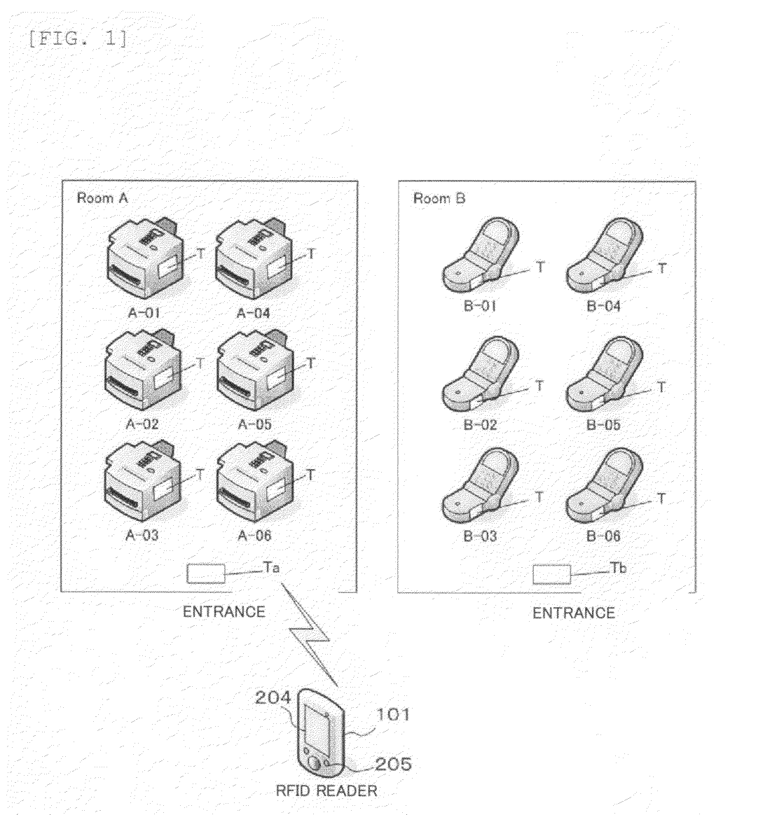

First, using FIG. 1, an outline of inventory of an article using such an article inventory device according to the present invention will be described. FIG. 1 is an explanatory diagram illustrating an outline of an inventory of an article according to a first embodiment of the present invention.

In FIG. 1, at an entrance of inventory areas Room A, Room B for making an inventory of an article, area tags Ta, Tb in which inventory area information indicating a area for making an inventory is recorded are installed. On articles A-01 to -06, B-01 to -06 as inventory targets stored in the inventory areas Room A, Room B, respectively (hereinafter referred to simply as “articles A, B” in description without discrimination), an article tag T in which identification information to identify each article A, B is recorded is affixed. In the first embodiment of the present invention, a case in which the article inventory device according to the present invention is realized by an RFID reader 101 will be described.

The RFID reader 101 reads an ID of an RFID tag present in a communication range on the basis of an operation input by a user in an input portion 205. Specifically, the RFID reader 101 reads the ID of the area tag Ta from the area tag Ta as inventory area information of the inventory area Room A at the entrance of the inventory area Room A and displays the fact that the area to make an inventory is the inventory area Room A on a display portion 204. Then, the RFID reader 101 reads an ID of an article tag T affixed to an article A as identification information of the article A stored in the inventory area Room A and the reading result is displayed on the display portion 204.

Similarly, the RFID reader 101 reads the ID of the area tag Tb from the area tag Tb at the entrance of the inventory area Room B on the basis of the operation input by the input portion 205 and displays the fact that the area to make an inventory is the inventory area Room B on the display portion 204. Then, the RFID reader 101 reads the ID of the article tag T affixed to an article B stored in the inventory area Room B and displays the readout result on the display portion 204.

Then, the RFID reader 101 displays states of the articles A, B in the inventory areas Room A, Room B where an inventory was made on the display portion 204 as an inventory result. Specifically, the RFID reader 101 displays an inventory abnormal state such as a state in which the articles A, B are not present (not present in the area where an inventory was made), a state in which the articles A, B are not correctly stored in a area where they should be stored on the display portion 204 and makes display to prompt return processing to return the inventory state to normal.

Then, the user operates the input portion 205 on the basis of the information displayed on the display portion 204 (display to prompt return processing) so that the return processing to the inventory normal state can be executed using the RFID reader 101.

(Hardware Configuration of the RFID Reader 101)

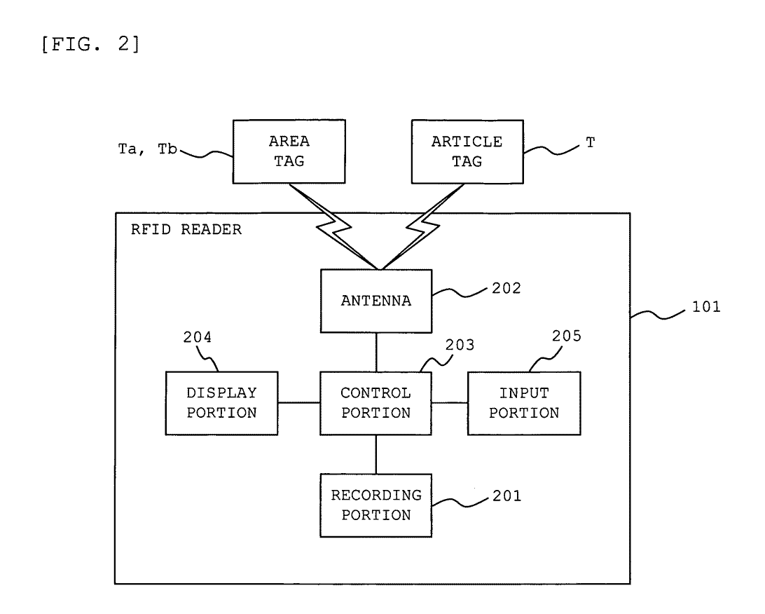

Subsequently, using FIG. 2, hardware configuration of the RFID reader 101 shown in FIG. 1 will be described. FIG. 2 is an explanatory diagram illustrating an example of a hardware configuration of the RFID reader according to the first embodiment of the present invention.

In FIG. 2, the RFID reader 101 is provided with a recording portion 201, an antenna 202, a control portion 203, the display portion 204, and the input portion 205.

The recording portion 201 is a hard disc (HD) or a flexible disc (FD) as an example of a detachable recording medium, and the recording portion 201 has its own drive device so that data is recorded according to control of the control portion 203. Also, data is read from the recording portion 201 according to the control of the respective drive devices.

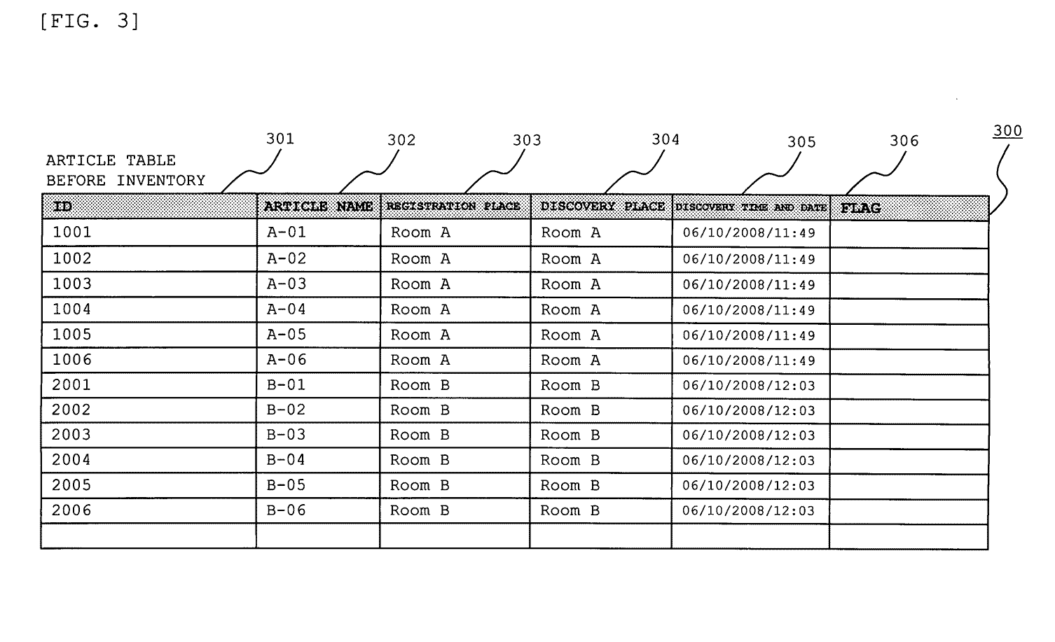

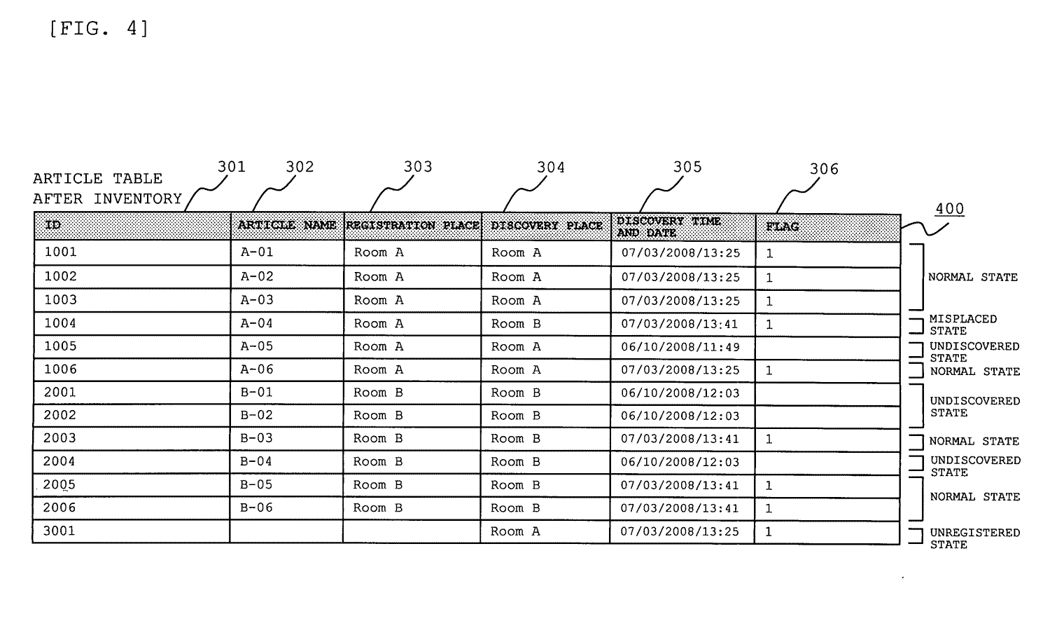

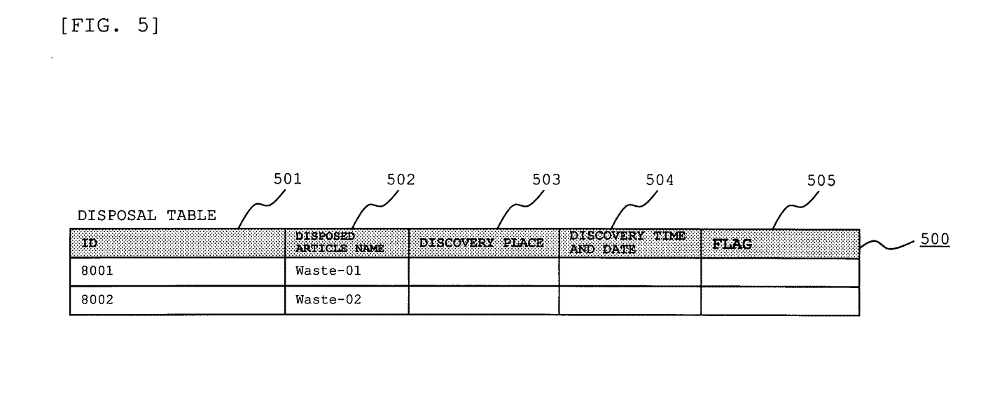

In the recording portion 201, various data such as an article list including registration identification information of the articles A, B registered in advance and storing area information indicating a area where the registered articles A, B should be contained is recorded. Specifically, in the recording portion 201, article tables 300, 400 (See FIGS. 3, 4) relating to inventory results of the articles A, B, a disposal table 500 (See FIG. 5) indicating disposed articles as article lists.

The antenna 202 conducts communication with the article tag T and the area tags Ta, Tb present in the communication range according to the control of the control portion 203. The antenna 202 reads the identification information and inventory area information through the communication with the article tag T, the area tags Ta, Tb and outputs the reading result to the control portion 203.

The control portion 203 governs control of the entire RFID reader 101. Specifically, the control portion 203 includes a Central Processing Unit (CPU), a Read-Only Memory (ROM), a Random Access Memory (RAM), and the ROM records various programs. Also, the RAM is used as a work area for the CPU.

In detail, the control portion 203 starts a control program of each component portion when the RFID reader 101 is powered on and carries out control of each component portion. For example, the control portion 203 controls the antenna 202 so as to read the identification information and inventory area information from the article tag T and the area tags Ta, Tb.

The control portion 203 determines if the registration identification information and storing area information in the article tables 300, 400 recorded in the recording portion 201 match with each other or not with regard to the identification information and inventory area information of the articles A, B read through the antenna 202.

If it is determined that at least either the identification information and registration identification information or the inventory area information and storing area information do not match with each other, the control portion 203 classifies the articles A, B into the inventory abnormal state. Specifically, the control portion 203 classifies the articles A, B whose identification information in the registration identification information has not been read into an undiscovered state. Also, the control portion 203 classifies the articles A, B whose identification information and the registration identification information match with each other into a misplaced state if the inventory area information and the storing area information do not match with each other. Also, the control portion 203 classifies the articles A, B not included in the registration identification information in the identification information read by the inventory into an unregistered state.

The control portion 203 executes the return processing to the inventory normal state for the articles A, B classified into the inventory abnormal state. Specifically, the control portion 203 reads the article tag T on the basis of the articles A, B classified into the undiscovered state. That is, the control portion 203 reads the article tag T of the articles A, B as search targets classified into the undiscovered state and updates the article table 400 on the basis of the reading result.

If the articles A, B are classified into the misplaced state, the control portion 203 updates the article table 400 on the basis of the inventory area information of the articles A, B. Specifically, if the inventory area information on the inventory of the articles A, B is different from the storing area information, the control portion 203 changes a discovery place 304 in the article table 400 to the inventory area information on the reading (inventory) of the identification information of the articles A, B. Also, if the articles A, B are classified into the misplaced state, the control portion 203 may read the article tag T of the articles A, B as search targets and notify the storing area information on the basis of the reading result. In this way, the articles A, B with the inventory area information different from the storing area information can be searched and returned to a area where the articles A, B should be contained.

The control portion 203 executes the return processing on the basis of the result of comparison between the identification information of the articles A, B and a disposal table 500 indicating the identification information of disposed articles if the articles A, B are classified into the unregistered state. Specifically, if the articles A, B classified into the unregistered state are present in the disposal table 500, it means that the articles A, B which should have been disposed of is still present, and the control portion 203 prompts the user to dispose of the articles A, B. If the articles A, B classified into the unregistered state is not present in the disposal table 500, the control portion 203 prompts the user to register the articles A, B in the article table 400.

The control portion 203 executes output control of the display portion 204 and notifies inventory result information. Specifically, the inventory result information may be information indicating an inventory abnormal state classified by the control portion 203. Also, the control portion 203 makes notification relating to the return processing to the user through the display portion 204. The control portion 203 receives various types of input information from the input portion 205 and controls the RFID reader 101 on the basis of the received input information. The input portion 205 includes a touch panel, operation buttons, for example, and the user makes various inputs therein.

In the first embodiment of the present invention, the case in which the articles A, B are classified into the inventory abnormal state is described, but if the identification information and the registration identification information as well as the inventory area information and the storing area information match with each other, respectively, it is the inventory normal state, and the fact that the inventory has been normal is notified to the user by display on the display portion 204 without executing the return processing.

The search mode has not been particularly described in the above, but the RFID reader 101 is provided with a plurality of search mode functions in order to conduct communication with an RFID tag (the area tags Ta, Tb and the article tag T). Specifically, the search mode functions include a single search mode, a multi search mode, a list-up mode, for example. The single search mode is processing in which a single RFID tag with which communication is to be made is specified and communication is continued in order to inquire if an RFID tag to be searched is present in the range of the communicable area of the RFID reader 101 or not all the time. The multi search mode is processing in which a plurality of the RFID tags with which communication is to be made is specified and communication is continued to inquire if an RFID tag to be searched is present in the range of the communicable area of the RFID reader 101 or not all the time.

The list-up mode is processing in which specification of a search target (that is, specification of identification information of an RFID tag) is not made but radio communication is made with an RFID tag present in the range of the communicable area of the RFID reader 101 so as to list up all the RFID tags whose identification information has been read. In the first embodiment of the present invention, the RFID reader 101 conducts communication with the RFID tag in the list-up mode in the inventory. Then, it may be so configured that the RFID tag to be searched is specified (that is, in the single search mode or the multi search mode) so as to make communication with the RFID tag as necessary.

Explaining each component element and each function in association with each other, the control portion 203 shown in FIG. 2 controls the antenna 202 so as to realize a function of a area information obtainment portion according to the present invention. Also, the control portion 203 controls the recording portion 201 so as to realize a function of a recording portion according to the present invention. Also, by means of processing by the control portion 203, functions of a determining portion and a classifying portion according to the present invention are realized. Also, the control portion 203 controls the display portion 204 so as to realize a function of a display device according to the present invention. Also, the control portion 203 controls the antenna 202 and the display portion 204 so as to realize a function of a return processing portion according to the present invention.

(Outline of Data)

Here, an outline of data used in inventory of articles according to the first embodiment of the present invention will be described using FIGS. 3 to 5. FIG. 3 is an explanatory diagram illustrating an outline of an article table before making an inventory according to the first embodiment of the present invention.

In FIG. 3, an article table 300 before making an inventory includes an ID 301 indicating article registration identification information of the articles A, B registered in advance, an article name 302 indicating an article name of the articles A, B, a registration place 303 indicating the storing area information, which is a area where the article should be contained, a discovery place 304 indicating the inventory area information on discovery at the previous inventory, a discovery time and date 305 indicating time and date of the previous inventory, and a flag 306 to be a check of the inventory. With regard to the ID 301, 1001 to 1006 as IDs of the article tags T are allocated to the articles A-01 to -06 and 2001 to 2006 to the articles B01 to 06, respectively. Though not shown, the IDs of the area tags Ta, Tb are also allocated to the room A, room B indicating the registration place 303 and the discovery place 304, respectively.

In this article table 300, since the registration place 303 and the discovery place 304 are the same for each of the articles A, B, the articles A, B at the previous inventory are in the state discovered in the correct storing areas (inventory normal state). In the first embodiment of the present invention, the article table 300 records the contents of the discovery place 304, the discovery time and date 305 relating to the information at the previous inventory, but it may be left blank so that an inventory is made.

FIG. 4 is an explanatory diagram illustrating the article table after inventory taking according to the first embodiment of the present invention. In an article table 400 after the inventory, the discovery place 304, the discovery time and date 305, and the flag 306 are rewritten from the article table 300 by the inventory taking. Specifically, if there is the registration identification information for the articles A, B whose identification information has been read by the RFID reader 101, “1” is written in the flag, and the discovery place 304 and the discovery time and date 305 are rewritten.

Here, if “1” is written in the flag 306 and the discovery place 304 matches the registration place 303, the articles A, B are classified into the inventory normal state. Specifically, in the article table 400, they are the articles A-01, 02, 03, 06, B-03, 05, 06. On the other hand, if “1” is written in the flag and the discovery place 304 does not match the registration place 303, the articles A, B are classified into the misplaced state. Specifically, in the article table 400, it is the article A-04.

If there is no registration identification information for the articles A, B whose identification information has been read by the RFID reader 101, the ID 301 is newly written, and the flag 306, the discovery place 304, and the discovery time and date 305 are written, respectively. That is, as shown in a lowermost row of the article table 400 (ID:3001), though “1” is written in the flag 306, the article with the article name 302 and the registration place 303 left blank is classified into the unregistered state.

For the articles A, B whose identification information has not been read by the RFID reader 101, corresponding information is not rewritten. That is, for the articles A-05, B-01, 02, 04 with the flag 306 left blank in the article table 400, the discovery place 304 and the discovery time and date 305 are not rewritten but classified into the undiscovered state.

FIG. 5 is an explanatory diagram illustrating a disposal table according to the first embodiment of the present invention. In FIG. 5, the disposal table 500 includes an ID 501 indicating identification information of a disposed article, a disposed article name 502 of the disposed article, a discovery place 503 indicating the inventory area information where identification information was read, a discovery time and date 504 indicating time and date when the identification information was read, and a flag 505 to be a check that the identification information is read.

The disposal table 500 is used to determine if the articles A, B classified into the unregistered state are disposed articles or not. If there is the ID 501 matching the identification information of the articles A, B classified into the unregistered state, the discovery place 503, the discovery time and date 504, and the flag 505 in the disposal table 500 are updated, and the user is prompted to dispose of the articles A, B.

(Contents of Processing by RFID Reader 101)

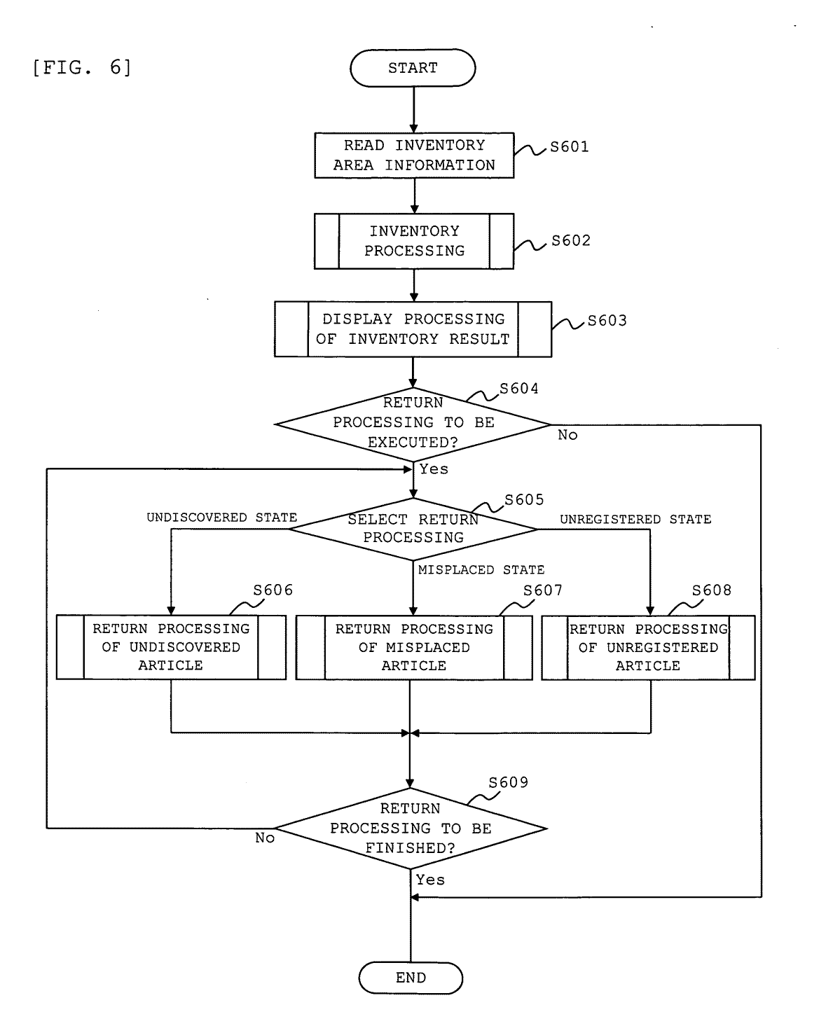

Contents of processing by the RFID reader 101 according to the first embodiment of the present invention will be described using FIGS. 6 to 12. FIG. 6 is a flowchart illustrating the contents of the processing by the RFID reader according to the first embodiment of the present invention.

In the flowchart in FIG. 6, first, the control portion 203 reads the inventory area information (Step S601). Specifically, reading of the inventory area information is started when the operation of the input portion 205 by the user is received, and the flag 306 in the article table 300 before the inventory is reset. Then, the control portion 203 controls the antenna 202 so as to read the information recorded in the area tags Ta, Tb.

The control portion 203 executes the inventory processing of the articles A, B in the inventory area by the inventory area information read at Step S601 (Step S602). Specifically, the control portion 203 controls the antenna 202 and conducts communication with the article tag T present in the communication range of the antenna 202 so as to read the identification information of the articles A, B.

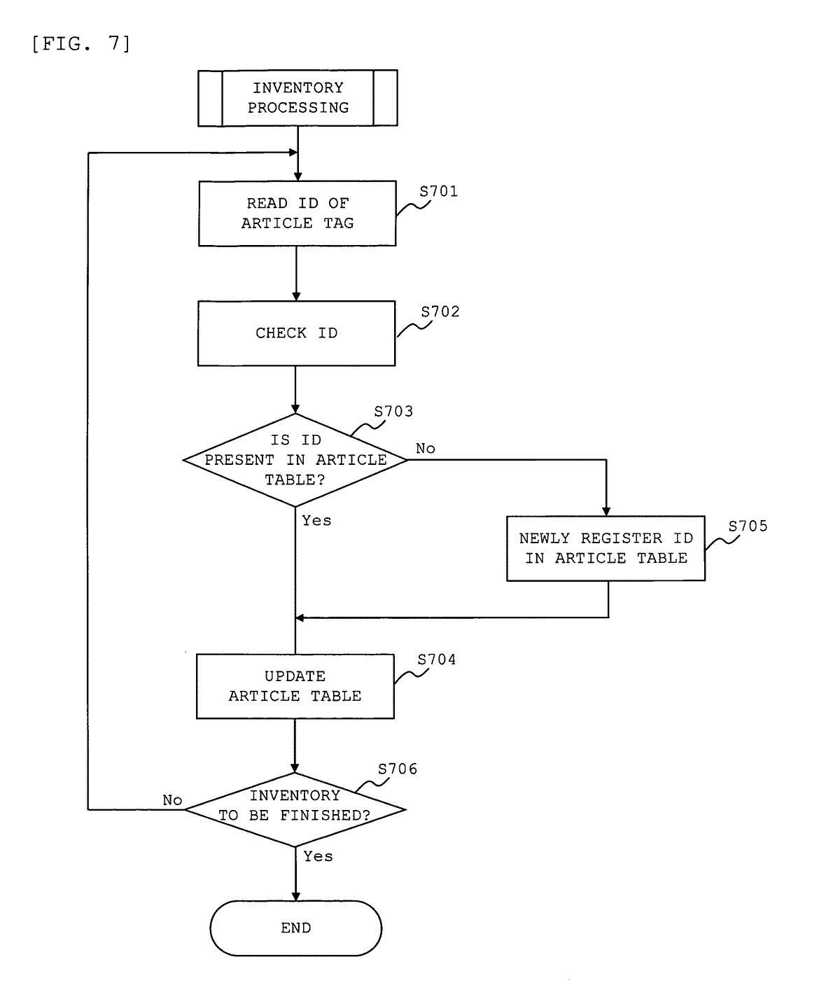

Here, the inventory processing (Step S602 shown in FIG. 6) in the RFID reader 101 according to the first embodiment of the present invention will be described using FIG. 7. FIG. 7 is a flowchart illustrating the contents of the inventory processing (Step S602 shown in FIG. 6) according to the first embodiment of the present invention. In the flowchart of FIG. 7, first, the control portion 203 controls the antenna 202 so as to read the ID of the article tag T (identification information of the articles A, B) affixed to the articles A, B in the inventory area (Step S701).

The control portion 203 checks the ID read at Step S701 with the article tables 300, 400 recorded in the recording portion 201 (Step S701). Specifically, the control portion 203 checks the ID 301 indicating the registration identification information in the article table 300 shown in FIG. 3 with the ID read at Step S701.

The control portion 203 determines if the ID read at Step S701 is present in the article table 300 or not as the result of the check at Step S702 (Step S703). At Step S703, if the read ID is present in the article table 300 (Step S703: Yes), the control portion 203 updates the article table 300 (Step S704). In this update of the article table 300, if there is an ID read at Step S701 for the ID 301 column in the article table 300 before the inventory, the discovery place 304 is written by the inventory area information, the discovery time and date 305 by the inventory time and date, and the flag 306 by “1” in the article table 400 after the inventory. Specifically, the rewriting is made as the articles A-01 to 04, 06, B-02, 05, 06 shown in the article table 400.

At Step S703, if the read ID is not present in the article table 300 (Step S703: No), the control portion 203 newly registers the ID read at Step S701 in the article table 300 (Step S705) so as to update the article table 300 (Step S705). In this update of the article table 300, the article name 302 and the registration place 303 are left blank, the discovery place 304 is rewritten by the inventory area information, the discovery time and date 305 by the inventory time and date, and the flag 306 by “1” in the article table 400 after the inventory. Specifically, rewriting is made as in the lowermost row shown in the article table 400 (ID: 3001).

Then, the control portion 203 determines if the inventory is to be finished or not (Step S706), and if it is not to be finished (Step S706: No), the routine returns to Step S701 so as to repeat the processing, while if it is to be finished (Step S706: Yes), the series of the inventory processing is finished, and the routine goes to Step S603 shown in FIG. 6. At Step S706, the inventory may be finished if the operation of an end button, not shown, by the user is received, if reading of the identification information of the articles A, B has been executed for more than a predetermined time, or if egress from the inventory area is detected.

Returning to FIG. 6, the control portion 203 executes display processing of a result of inventory taken at Step S602 (Step S603). Specifically, the control portion 203 classifies the inventory results and executes output control of the display portion 204 on the basis of the classified inventory results.

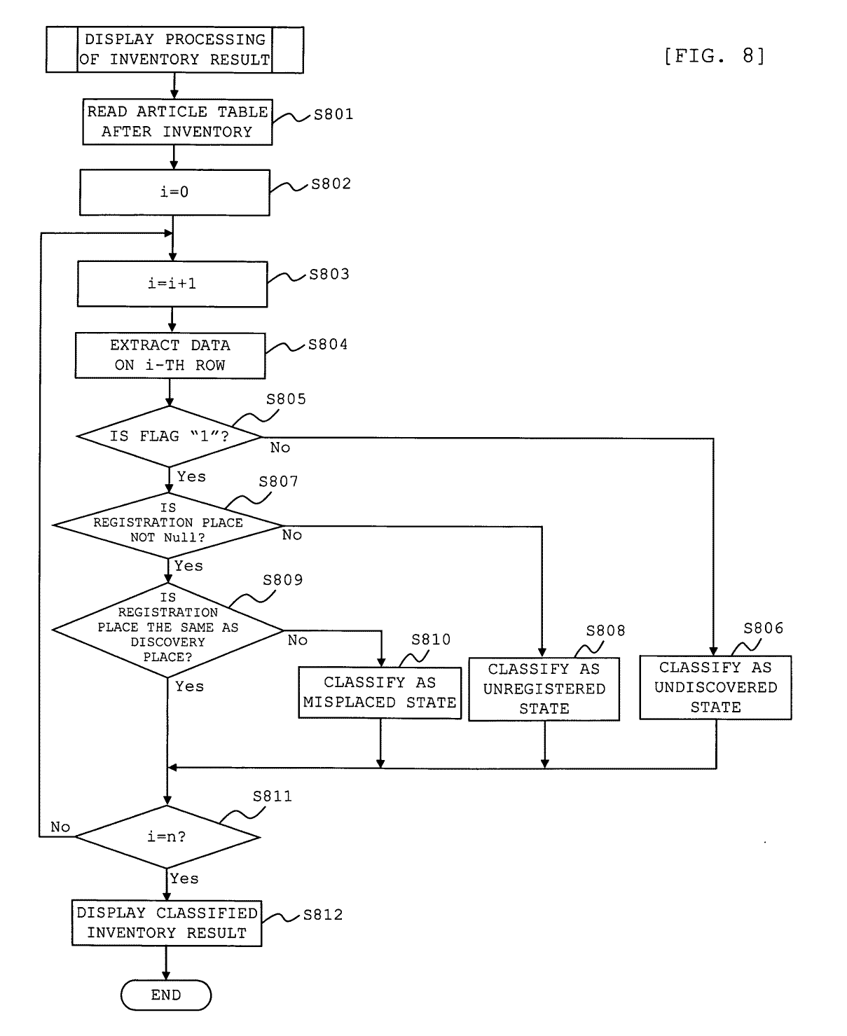

Here, using FIG. 8, display processing (Step S603 shown in FIG. 6) of the inventory results in the RFID reader 101 according to the first embodiment of the present invention will be described. FIG. 8 is a flowchart illustrating the contents of the display processing (Step S603 shown in FIG. 6) of the inventory results according to the first embodiment of the present invention. In the flowchart in FIG. 8, first, the control portion 203 reads the article table 400 after the inventory from the recording portion 201 (Step S801).

The control portion 203 initializes the i-th row from the top in the article table 400 from 1 to n rows read at Step S801 to i=0 (Step S802) and increments (i=i+1)(Step S803).

The control portion 203 extracts the i-th data in the article table 400 read at Step S801 (Step S804). The control portion 203 determines if the flag 306 in the data extracted at Step S804 is “1” or not (Step S805).

At Step S805, if the flag 306 is not “1” (Step S805: No), the control portion 203 classifies the data extracted at Step S805 into the undiscovered state (Step S806), and the routine goes to Step S811. Specifically, the articles A-05, B01, 02, 04 in the article table 400 shown in FIG. 4 are classified into the undiscovered state.

At Step S805, if the flag 306 is “1” (Step S805: Yes), the control portion 203 determines if the registration place 303 is not Null (blank) (Step S807).

At Step S807, if the registration place 303 is Null (Step S807: No), the control portion 203 classifies the data extracted at Step S805 into the unregistered state (Step S806), and the routine goes to Step S811. Specifically, the lowermost row (ID: 3001) in the article table 400 shown in FIG. 4 is classified into the unregistered state.

At Step S807, if the registration place 303 is not Null (Step S807: Yes), the control portion 203 determines if the registration place 303 and the discovery place 304 are the same or not (Step S809).

At Step S809, if the registration place 303 and the discovery place 304 are not the same (Step S809: No), the control portion 203 classifies the data extracted at Step S805 into the misplaced state (Step S810), and the routine goes to Step S811. Specifically, the article A-04 in the article table 400 shown in FIG. 4 is classified into the misplaced state.

At Step S809, if the registration place 303 and the discovery place 304 are the same (Step S809: Yes), the control portion 203 determines if it is i=n or not (Step S811). That is, the control portion 203 determines if all the items in the article table 400 have been checked at Step S811 or not.

At Step S811, if it is not i=n (Step S811: No), the routine returns to Step S803 and the processing is repeated. If at Step S811, it is i=n (Step S811: Yes), the inventory result classified at Steps S806, 908 and 910 is displayed (Step S812), display processing of the series of the inventory results is finished, and the routine goes to Step S604 shown in FIG. 6. Specifically, in the display processing of the inventory result, an inventory result display screen 900, which will be described later, is displayed by the control portion 203 on the display portion 204.

(Outline of Display of the Inventory Result Information)

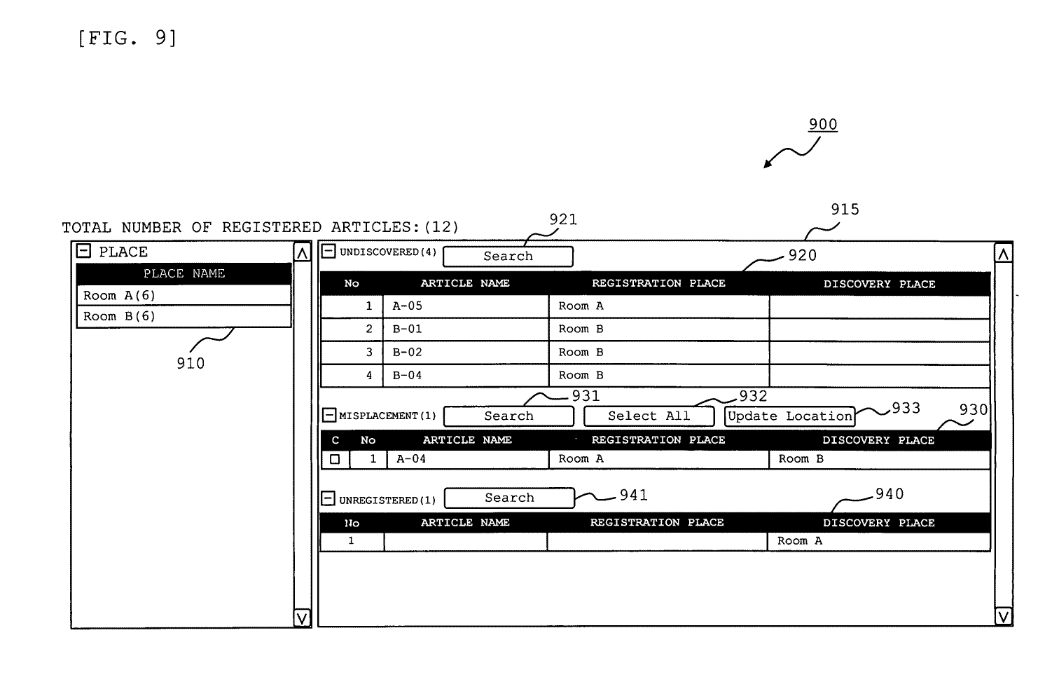

Here, the inventory result displayed in the RFID reader 101 according to the first embodiment of the present invention will be described using FIG. 9. FIG. 9 is an explanatory diagram illustrating an example of the inventory result display screen according to the first embodiment of the present invention.

In FIG. 9, the inventory result display screen 900 includes an inventory area display portion 910 showing a area where an inventory is made and an inventory abnormal state display portion 915 showing an inventory abnormal state. The inventory abnormal state display portion 915 includes an undiscovery display portion 920 showing an undiscovered state, a misplacement display portion 930 showing a misplaced state, and an unregistered state display portion 940 showing an unregistered state. In the undiscovery display portion 920, the misplacement display portion 930, and the unregistered state display portion 940, respectively corresponding processing selection buttons 921, 931, 932, 933 and 941 are displayed.

In the inventory area display portion 910, areas where the inventory was made are displayed in a list. In the undiscovery display portion 920, the articles A, B classified into the undiscovered state and the registration places indicating the registered storing area information are displayed in a list. Specifically, it is constituted such that the registered articles with a blank flag in the article table 400 shown in FIG. 4 are displayed. The RFID reader 101 prompts the user to specify the articles A, B classified into the undiscovered state as search targets using the processing selection button 921 and executes the return processing to the inventory normal state.

In the misplaced state display portion 930, the articles A, B classified into the misplaced state, the registration places registered in advance, and the discovery places where the articles A, B are read are displayed in a list. Specifically, the article table 400 shown in FIG. 4 is constituted such that “1” is written in the flag 306 and the articles A, B whose discovery places 304 do not match the registration places 303 are displayed. The RFID reader 101 executes the return processing to the inventory normal state by the processing selection buttons 931 to 933 selected by the user.

Specifically, in the return processing, the user is prompted to set the articles A, B classified into the misplaced state as search targets by the processing selection button 931 so as to bring it to the inventory normal state. Also, the return processing may be constituted such that the storing area information is updated to the inventory area information in which identification information of the articles A, B has been read (an inventory was made). The articles A, B to be a target of the return processing may be selected one by one but may be able to be selected in a lump by the processing selection button 932.

In the unregistered state display portion 940, the articles A, B classified into the unregistered state and the discovery places where the identification information was read are displayed in a list. Specifically, though “1” is written in the flag 306 in the article table 400 shown in FIG. 4, the articles A, B leaving the article name 302 and the registration place 303 blank are displayed in this constitution. The RFID reader 101 prompts the user to set the articles A, B classified into the unregistered state as search targets by the processing selection button 941 and executes the return processing to the inventory normal state.

Returning to FIG. 6, the control portion 203 determines if the return processing is to be executed or not on the basis of the inventory result displayed in the display processing of the inventory result at Step S603 (Step S604). Specifically, the control portion 203 determines if the return processing is to be executed or not based on whether the inventory abnormal state is indicated in the inventory results displayed at Step S603 or not.

At Step S604, if the return processing is not to be executed (Step S604: No), the series of processing is finished as it is. That is, if the articles A, B are all in the inventory normal state at Step S604, the return processing is not to be executed but the processing is finished as it is.

If the return processing is to be executed at Step S604 (Step S604: Yes), the routine goes to Step S605, where the control portion 203 makes a selection on the return processing to the inventory abnormal state (Step S605). Specifically, the selection of the return processing is made by displaying the inventory result display screen 900 by the display processing at Step S603 and on the basis of the processing selection buttons 921, 931, 932, 933 and 941 selected by the user. Specifically, the selection from the processing selection buttons 921, 931, 932, 933 and 941 may be made by operating the input portion 205, for example, and selecting a touch-panel type processing selection buttons 921, 931, 932, 933 and 941 or by pointing the processing selection buttons 921, 931, 932, 933 and 941 by an arrow icon, not shown.

If the processing selection button 921 corresponding to the undiscovered state is selected at Step S605, the routine goes to Step S606, where the control portion 203 executes the return processing of the undiscovered article in the undiscovered state (Step S606).

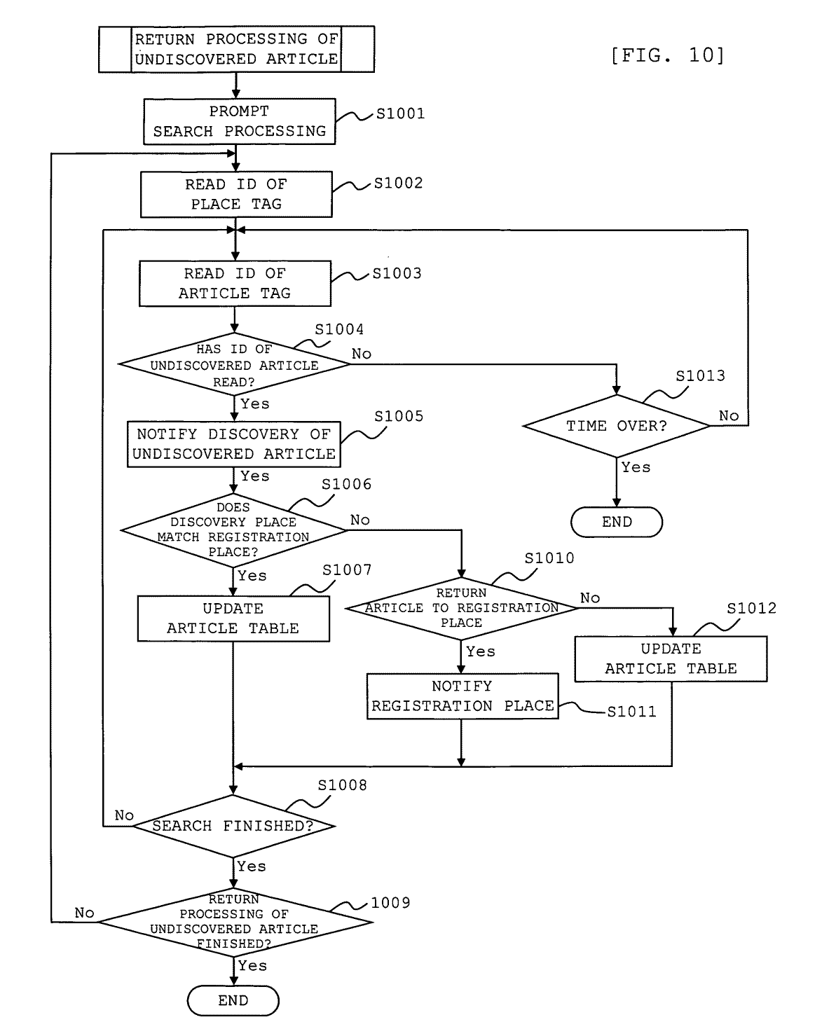

Here, the return processing of the undiscovered article in the RFID reader 101 (Step S606 shown in FIG. 6) according to the first embodiment of the present invention will be described using FIG. 10. FIG. 10 is a flowchart illustrating contents of the return processing (Step S606 shown in FIG. 6) of the undiscovered article according to the first embodiment of the present invention. In the flowchart of the FIG. 10, first, the control portion 203 prompts the user to proceed with search processing for the undiscovered article by controlling the display portion 204 (Step S1001). Specifically, the control portion 203 prompts for selection of the processing selection button 921 by the search result display screen 900 so that the undiscovered article is set as a search target.

The control portion 203 reads an ID of a place tag of a place to be searched (inventory area information in the area tag Ta or Tb) (Step S1002). Specifically, the control portion 203 controls the antenna 202 and reads the inventory area information of the area tag Ta or Tb to be searched.

The control portion 203 controls the antenna 202 so as to read the ID of the article tag T affixed to the articles A, B in the searched area (Step S1003) and determines if the ID of the undiscovered article has been read or not (Step S1004).

At Step S1004, if the ID of the undiscovered article has not been read (Step S1004: No), if time is over or not is determined (Step S1013). The time is over when the time during which the ID of an article cannot be read has elapsed a predetermined time set in advance, for example.

At Step S1013, if the time is over (Step S1013: Yes), the fact that there is no undiscovered article is notified to the user, and the series of return processing of the undiscovered article is finished, and the routine goes to Step S609 shown in FIG. 6. Instead of the determination of if the time is over or not, a predetermined number of retry times for the reading of the ID of the undiscovered article may be set so that it is determined if the number of retry times is exceeded or not. At Step S1013, if the time has not been over (Step S1013: Yes), the routine returns to Step S1003 and the processing is repeated.

At Step S1004, if the ID of the undiscovered article has been read (Step S1004: Yes), the control portion 203 controls the display portion 204 and a speaker, not shown, so that the discovery of the undiscovered article is notified to the user (Step S1005).

The control portion 203 determines if the discovery place of the undiscovered article matches the registration place or not (Step S1006). Specifically, the control portion 203 determines if the inventory area information read at Step S1002 matches the storing area information of the article classified into the undiscovered state.

At Step S1006, if the discovery place of the undiscovered article matches the registration place (Step S1006: Yes), the control portion 203 updates the article table 300 (Step S1007), and the routine goes to Step S1008. Specifically, in the article table 300, with regard to the article classified into the undiscovered state, the discovery place 304 is rewritten to the discovery place or the registration place (Room A or Room B) and the flag 306 to “1” as the article table 400.

At Step S1006, if the discovery place of the undiscovered article does not match the registration place (Step S1006: No), it is determined if the discovered undiscovered article is to be returned to the registration place or not (Step S1010). The determination of whether to return it to the registration place or not is made by receiving selection on the return or not from the user, for example.

At Step S1010, if the article is to be returned to the registration place (Step S1010: Yes), the control portion 203 controls the display portion 204 to notify the registration place to the user (Step S1011), and the routine goes to Step S1008.

At Step S1010, if the article is not to be returned to the registration place (Step S1010), the control portion 203 updates the article table 300 (Step S1012), and the routine goes to Step S1008. In the article table 300, with regard to the article classified into the undiscovered state, the registration place 303 and the discovery place 304 are rewritten to the discovery place (Room A or Room B) and the flag 306 to “1” as the article table 400.

The control portion 203 determines if the search of the place where the inventory area information of the place tag was read at Step S1002 has been finished or not (Step S1008). The determination on an end of the search is made when all the undiscovered articles have been discovered or when an end button, not shown, is selected by the user.

At Step S1008, if the search of the place where the inventory area information of the place tag was read at Step S1002 has not been finished (Step S1008: No), the routine returns to Step S1003 and the processing is repeated, while if the search is finished (Step S1008: Yes), the control portion 203 determines if the return processing of the undiscovered article is to be finished or not (Step S1009). The determination on the end is made when all the undiscovered articles have been discovered or when an end button, not shown, is selected by the user.

At Step S1009, if the return processing is not to be finished (Step S1009: No), the routine returns to Step S1002 and the processing is repeated, while if the return processing is to be finished (Step S1009: Yes), the series of the return processing of the undiscovered article is finished as it is, and the routine goes to Step S609 shown in FIG. 6.

Also, at Step S605, if the processing selection buttons 931, 932 and 933 corresponding to the misplaced state are selected, the routine goes to Step S607, where the control portion 203 executes the return processing of the misplaced article in the misplaced state (Step S607).

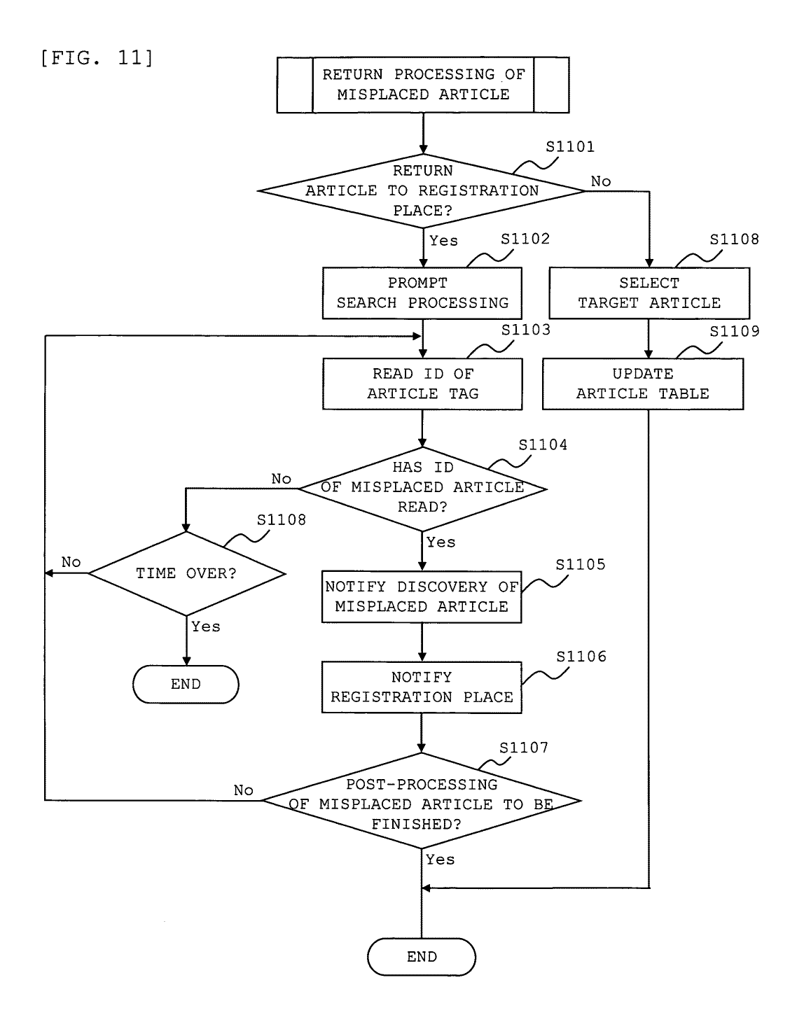

Here, the return processing of the misplaced article in the RFID reader 101 (Step S607 shown in FIG. 6) according to the first embodiment of the present invention will be described using FIG. 11. FIG. 11 is a flowchart illustrating contents of the return processing of the misplaced article (Step S607 shown in FIG. 6) according to the first embodiment of the present invention. In the flowchart in FIG. 11, first, the control portion 203 determines if the user is to return the articles A, B in the misplaced state to the registration place or not by controlling the display portion 204 (Step S1101). The determination on whether or not to return it to the registration place is made on the basis of the processing selection buttons 931, 932 and 933 shown in FIG. 9, for example.

At Step S1101, if the article is not to be returned to the registration place (Step S1101: No), selection of the targeted misplaced article is received (Step S1108). Specifically, the control portion 203 updates the article table 300 without returning the misplaced article to the registration place when the processing selection buttons 932, 933 are selected.

Then, the control portion 203 updates the registration place 303 in the article table 300 with the discovery place 304 (Step S1109) for the selected misplaced article and finishes the series of the return processing of the misplaced article.

At Step S1101, when the article is to be returned to the registration place (Step S1101: Yes), the control portion 203 controls the display portion 204 and prompts the user for the search processing of the misplaced article (Step S1102). Specifically, the control portion 203 sets the misplaced article as a search target if the processing selection button 931 is selected and notifies the discovery place.

The control portion 203 controls the antenna 202 to read an ID of the article tag T affixed to the articles A, B located in the discovery place (Step S1103) and determines if the ID of the misplaced article has been read or not (Step S1104).

At Step S1104, if the ID of the misplaced article has not been read (Step S1104: No), it is determined if time is over or not (Step S1108).

At Step S1108, if time is over (Step S1108: Yes), the series of the return processing of the undiscovered article is finished by notifying the user that the misplaced article was not found, and the routine goes to Step S609 shown in FIG. 6. At Step S1108, if time is not over (Step S1108: Yes), the routine returns to Step S1103 and the processing is repeated.

At Step S1104, if the ID of the misplaced article has been read (Step S1104: Yes), the control portion 203 notifies the user that the misplaced article was found by controlling the display portion 204 or a speaker, not shown.

Then, the control portion 203 notifies the user of the registration place by controlling the display portion 204 in order to return the misplaced article to the registration place (Step S1106) and determines if the return processing of the misplaced article is to be finished or not (Step S1107). The determination on an end is made when all the misplaced articles have been found or when the end button, not shown, is selected by the user.

At Step S1107, if the return processing is not to be finished (Step S1107: No), the routine returns to Step S1103 and the processing is repeated, while if the return processing is to be finished (Step S1103: Yes), the series of the return processing of the misplaced article is finished as it is, and the routine goes to Step S609 shown in FIG. 6.

If, at Step S605, the processing selection button 941 corresponding to the unregistered state is selected, the routine goes to Step S608, where the control portion 203 executes the return processing of the unregistered article in the unregistered state (Step S608).

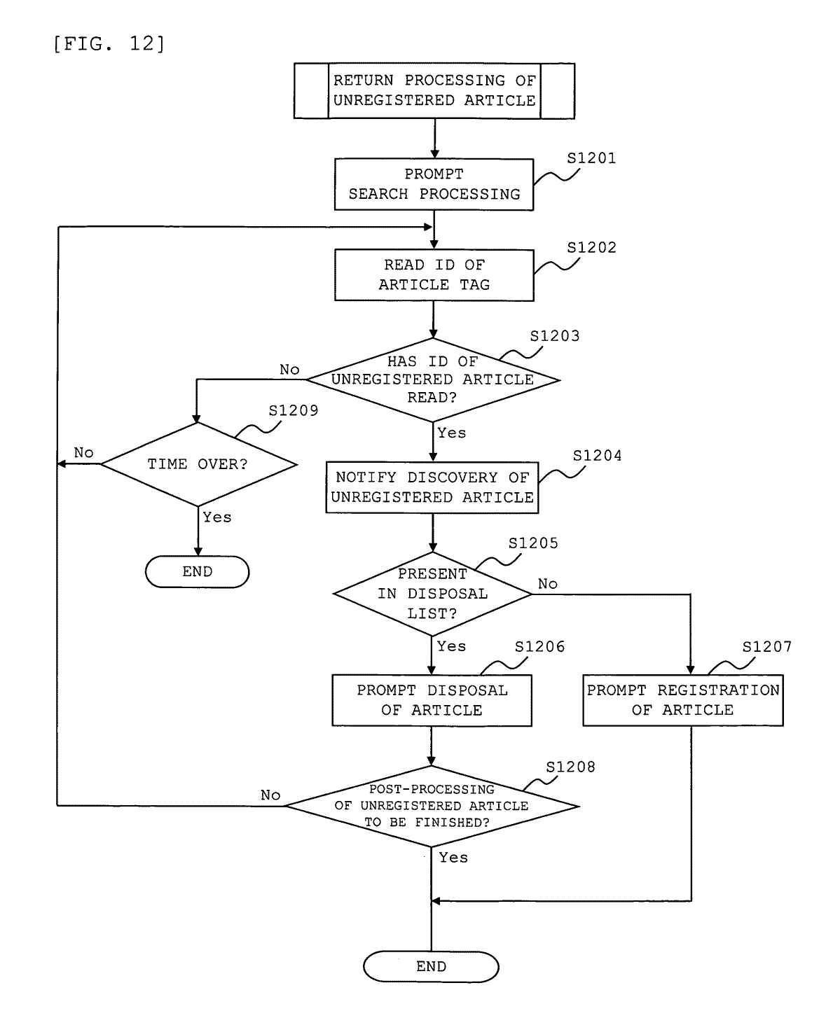

Here, the return processing of the unregistered article in the RFID reader 101 (Step S608 shown in FIG. 6) according to the first embodiment of the present invention will be described using FIG. 12. FIG. 12 is a flowchart illustrating contents of the return processing of the unregistered article (Step S608 shown in FIG. 6) according to the first embodiment of the present invention. In the flowchart in FIG. 12, first, the control portion 203 controls the display portion 204 and prompts the user for the search processing of the articles A, B in the unregistered state (Step S1201). Specifically, the control portion 203 prompts selection of the processing selection button 941 by the search result display screen 900 so as to set the unregistered article as a search target and notifies the discovery place.

The control portion 203 controls the antenna 202 and reads an ID of the article tag T affixed to the articles A, B located in the discovery place (Step S1202) and determines if the ID of the unregistered article has been read or not (Step S1203).

At Step S1203, if the ID of the unregistered article has not been read (Step S1203: No), it is determined if time is over or not (Step S1209).

At Step S1209, if time is over (Step S1209: Yes), the series of the return processing of the unregistered article is finished by notifying the user that the unregistered article was not found, and the routine goes to Step S609 shown in FIG. 6. At Step S1209, if time is not over (Step S1013: Yes), the routine returns to Step S1202 and the processing is repeated.

At Step S1203, if the ID of the unregistered article has been read (Step S1203: Yes), the control portion 203 notifies the user that the unregistered article was found by controlling the display portion 204 or a speaker, not shown (Step S1204).

The control portion 203 checks the ID of the unregistered article read at Step S1203 with the disposal list 500 recorded in the recording portion 201 so as to determine if the ID of the read unregistered article is present in the disposal list 500 or not (Step S1205).

At Step S1205, if the ID of the unregistered article is present in the disposal list 500 (Step S1205: Yes), the control portion 203 prompts the user for disposal of the unregistered article (Step S1206). Specifically, the control portion 203 displays that the unregistered article should have been already disposed of by controlling the display portion 204 and prompts the user for the disposal.

At Step S1205, if the ID of the unregistered article is not present in the disposal list 500 (Step S1205: No), the control portion 203 prompts the user to register the unregistered article (Step S1207). Specifically, the control portion 203 displays that the unregistered article is not a disposed article but needs new registration by controlling the display portion 204 and prompts the user for registration.

The control portion 203 determines if the return processing of the unregistered article is to be finished or not (Step S1208). The determination on an end is made when all the unregistered articles have been found or when the end button, not shown, is selected by the user.

At Step S1208, if the return processing is not to be finished (Step S1208: No), the routine returns to Step S1202 and the processing is repeated, while if the return processing is to be finished (Step S1208: Yes), the series of the return processing of the unregistered article is finished as it is, and the routine goes to Step S609 shown in FIG. 6.

Returning to FIG. 6, when any of Steps S606, 707 and 708 is finished, the control portion 203 determines if the return processing is to be finished or not (Step S609). The determination on end of the return processing is made when the inventory abnormal state is returned to the inventory normal state. It may also be finished when the return processing has been executed for all the inventory abnormal states or when an end button, not shown, is selected by the user.

The processing in each component element of the present invention and each processing in the first embodiment of the present invention will be described in association with each function. By means of the processing by the antenna 202 and the control portion 203 at Step S601 described in the flowchart of FIG. 6, the processing of an area information obtainment portion according to the present invention is executed. By means of the processing by the control portion 203 and the display portion 204 at Step S602 and Step S603, the processing of a determining portion, a classifying portion, and a display device according to the present invention is executed. By means of the processing by the antenna 202, the control portion 203, and the display portion 204 at Step S604 to Step S609, the processing of a return processing portion according to the present invention is executed.

As described above, the RFID reader according to the first embodiment of the present invention can keep a storage state of the articles normal by having the user take an appropriate measure for the articles classified into the inventory abnormal state. Specifically, by execution of the search processing for the articles classified into the undiscovered state as search targets, it is possible to update the article list according to the search result and to return the articles to the registration place.

Also, with regard to the articles classified into the misplaced state, it is possible to change the registration place thereof in the article list and return them to the normal state and to execute the search processing using the articles classified into misplacement as search targets to be returned to the registration place. Moreover, with regard to the articles classified into the unregistered state, disposal or registration of the articles can be executed after confirming if the article is to be disposed of or not.

(Variations of Other Functions)

Particularly in the first embodiment of the present invention, as an example of the processing of the area information obtainment portion, reading of the inventory area information of the area tag at Step S601 shown in FIG. 6 is described, but not limited to that. Specifically, by configuring such that a position calculation portion such as a GPS (Global Positioning System) is provided in the RFID reader, for example, the area information for making an inventory can be obtained. In this way, the inventory can be made without providing the area tag in the inventory area.

Particularly in the first embodiment of the present invention, making an inventory by reading the area tag at Step S601 shown in FIG. 6 and then, by reading the article tag at Step S602 is described, but not limited to that. Specifically, the RFID reader reads the RFID tag without discriminating the area tag and the article tag, for example. If the RFID reader executes processing by determining which of the article or the place the RFID tag indicates, the user can make an inventory easily without taking time to select and read the area tag in order to obtain the inventory area information.

Also, particularly in the first embodiment of the present invention, as an example of the inventory result display screen by the display device, display of the inventory result display screen 900 shown in FIG. 9 on the display portion 204 is described, but not limited to that. Specifically, by using the information in the article table 400 after the inventory shown in FIG. 4, for example, the inventory normal state may also be displayed with the inventory abnormal state. As a result, the user can easily recognize that the inventory was normally made.

Also, particularly in the first embodiment of the present invention, the processing made by the processing selection buttons 921, 931, 932, 933 and 941 selected by the user according to the inventory abnormal state at Step S604 and Step S605 shown in FIG. 6 is described, but not limited to that. Specifically, priority ranks may be set for each inventory abnormal state so that the return processing is executed automatically according to the priorities, for example. In this case, for the undiscovered state or unregistered state, the search processing may be executed automatically without prompting for the search processing as shown at Step S1001 or Step S1201. Also, the processing may be configured to be finished without executing the return processing if a cancel button, not shown, is selected by the user.

Though it is configured such that with regard to the misplaced state, whether or not to return the article to the registration place is determined at Step S1101 on the basis of the processing selection buttons 931, 932 and 933, but not limited to that. Specifically, attributes (categories) may be set for each of the registration places and articles, for example, so that it may be determined that the article in the same category does not have to be returned to the registration place even if the place is different, for example.

More specifically, in a case of book management in a library, a category of world literature and a category of novels might be set for storage places and books. If a book for which the category of world literature is set is located in a storage place for which the category of world literature is set does not have to be returned to the registration place even if it is located in a place different from the registration place. On the other hand, if a book for which the category of novels is set is located in a storage place for which the category of world literature is set, it may be so configured that determination is made so that the book is automatically returned to the registration place. Alternatively, a plurality of places available for storage may be registered for articles. By automatically moving to the return processing as above, an appropriate measure against the inventory abnormal state can be taken without forcing a burden on the user.

Particularly in the first embodiment of the present invention, it is so configured that the search processing is prompted with the undiscovered article as a search target at Step S1001. In this search processing, if the undiscovered article has been discovered at the previous inventory, the record of the previous discovery place and the discovery time and date may be left as reference information. With this arrangement, the user can perform the search processing referring to the previous state of the undiscovered article.

Particularly in the first embodiment of the present invention, it is configured such that the registration place is notified when the article is to be returned to the registration place at Step S1011 and Step S1106, but it may be so configured that return to the registration place can be confirmed. Specifically, for example, the RFID reader reads the area tag after the user has returned the article to the registration place. With this arrangement, return to the inventory normal state can be ensured.

Also, particularly in the first embodiment of the present invention, if the article in the unregistered state is in the disposal list at Step S1205 and Step S1206 shown in FIG. 12, the disposal is prompted, but it may be so configured that re-registration is prompted. Also, if the article in the unregistered state is not in the disposal list at Step S1205 and Step S1207, registration is prompted, but it may be so set that the article is ignored in reading after that as an article not relating to the inventory. With this arrangement, an appropriate inventory can be taken for the article in the unregistered state next time and after.

Though not particularly described in the first embodiment of the present invention, the selection of the return processing at Steps S603 to S605 shown in FIG. 6 is configured to be made on the basis of the display relating to the inventory result of the plurality of inventory areas (inventory areas Room A, Room B in the first embodiment). At this time, if the identification information of the same article tag T is read in duplication in the plurality of inventory areas, the same inventory area as the storing area may be given priority and employed as an inventory result. Though not shown, it may be so set that the article tag T of an article in another inventory area cannot be read even if an inventory is made in the inventory area due to a shield structure such as a wall between the inventory areas.

### Second Embodiment

(Outline of the Article Inventory System)

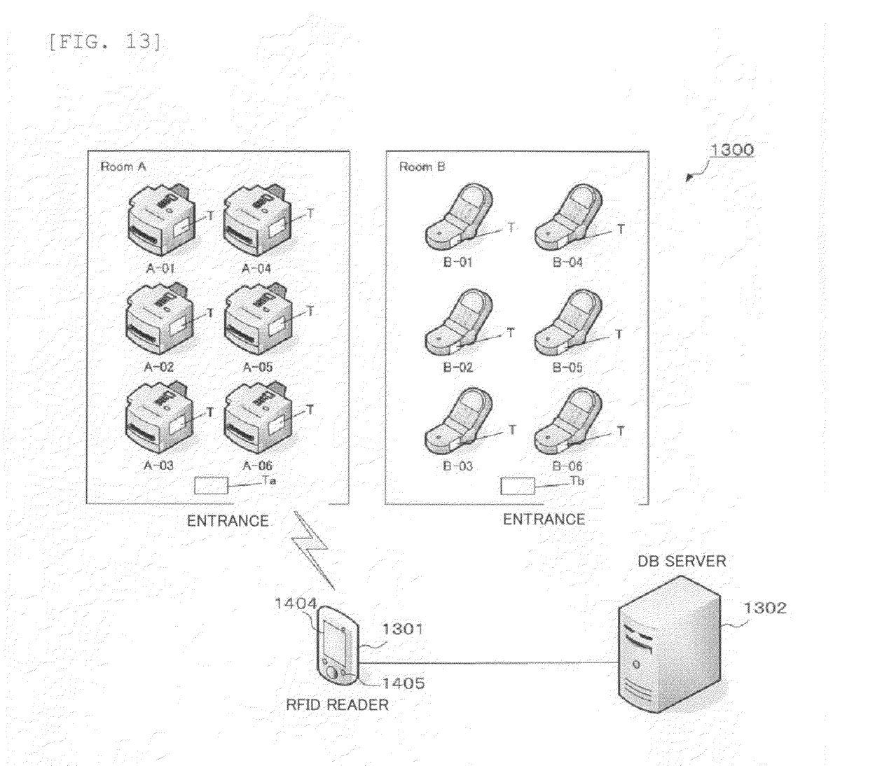

Subsequently, a second embodiment of the present invention will be described. In the second embodiment of the present invention, a case in which the function by the RFID reader 101 shown in the above-described first embodiment is realized using the RFID reader and a database (DB) server will be described. Specifically, it is so configured that communication with the RFID tag is conducted by the RFID reader, and the article list is recorded in the DB server, for example. First, using FIG. 13, outline of the article inventory system according to the second embodiment of the present invention will be described. FIG. 13 is an explanatory diagram illustrating the outline of the article inventory system according to the second embodiment of the present invention. In the outline of the article inventory system according to the second embodiment of the present invention, those similar to the portions in FIG. 1 shown in the first embodiment are given the same reference numerals, and description thereof will be omitted.

In FIG. 13, an article inventory system 1300 includes an RFID reader 1301, a DB server 1302, the area tags Ta, Tb installed at the entrances of the inventory areas Room A, Room B, and the article tag T in which identification information of each of the articles A, B affixed to the articles A, B is recorded. In the second embodiment of the present invention, a case in which an apparatus for communicating with an RFID tag according to the present invention is realized by the RFID reader 1301 and the database according to the present invention by the DB server 1302 will be described. Coupling between the RFID reader 1301 and the DB server 1302 is not limited to wired or wireless but may be coupled through Bluetooth (registered trademark).

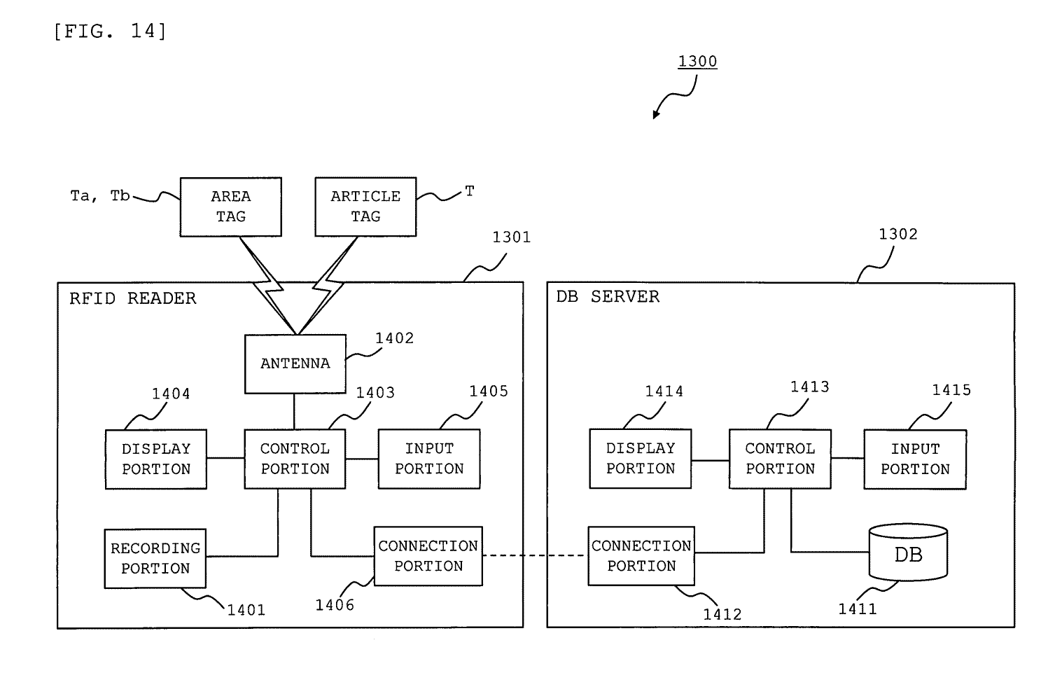

The RFID reader 1301 reads the ID of the RFID tag present in the communication range on the basis of the operation input by a user from an input portion 1405 (See FIG. 14), and transmits the read information to the DB server 1302. Specifically, the RFID reader 1301 reads the ID of the area tag Ta as the inventory area information of the inventory area Room A from the area tag Ta at the entrance of the inventory area Room A and transmits it to the DB server 1302. When the RFID reader 1301 receives information indicating that the area to make an inventory is the inventory area Room A from the DB server 1302, the fact is displayed on the display portion 1404 (See FIG. 14). Also, the RFID reader 1301 reads the ID of the article tag T affixed to the article A as the identification information of the article A stored in the inventory area Room A and transmits it to the DB server 1302.

The DB server 1302 specifies a area for the RFID reader 1301 to make an inventory from the ID of the area tag Ta transmitted from the RFID reader 1301 and transmits the information that the area to make an inventory is the inventory area Room A to the RFID reader 1301. Also, the DB server 1302 makes an inventory of the article A in the inventory area Room A from the ID of the article tag T affixed to the article A transmitted from the RFID reader 1301 and displays the result on the display portion 1414 (See FIG. 14, not shown).

Similarly, the RFID reader 1301 reads the ID of the area tag Tb from the area tag Tb at the entrance of the inventory area Room B on the basis of the operation input by the input portion 1405 and transmits it to the DB server 1302. When the RFID reader 1301 receives the information indicating that the area to make an inventory from now is the inventory area Room B from the DB server 1302, the reader displays the fact on the display portion 1404. Also, the RFID reader 1301 reads the ID of the article tag T affixed to the article B stored in the inventory area Room B and transmits it to the DB server 1302.

The DB server 1302 specifies a area for the RFID reader 1301 to make an inventory from the ID of the area tag Tb transmitted from the RFID reader 1301 and transmits the information that the area to make an inventory is the inventory area Room B to the RFID reader 1301. Also, the DB server 1302 makes an inventory of the article B in the inventory area Room B from the ID of the article tag T affixed to the article B transmitted from the RFID reader 1301 and displays the result on the display portion 1414.

Specifically, the DB server 1302 displays the inventory abnormal state such as a state in which the articles A, B are not present (not present in an area where an inventory is made) or a state in which the articles A, B are not correctly contained in a area where they should be contained on the display portion 1414. Moreover, the DB server 1302 makes display to prompt for the return processing to return the inventory state to the normal one. Also, the DB server 1302 outputs, for the return processing, a search instruction to the RFID reader 1301 with the articles A, B classified into the inventory abnormal state as a search target. Then, the RFID reader 1301 can make a search of the articles A, B classified into the inventory abnormal state on the basis of the search instruction output from the DB server 1302.

(Hardware Configuration of the Article Inventory System 1300)

Subsequently, using FIG. 14, the hardware configuration of the article inventory system 1300 shown in FIG. 14 will be described. FIG. 14 is an explanatory diagram illustrating an example of the hardware configuration of the article inventory system according to the second embodiment of the present invention.

In FIG. 14, the RFID reader 1301 is provided with a recording portion 1401, an antenna 1402, a control portion 1403, a display portion 1404, an input portion 1405, and a connection portion 1406.

The recording portion 1401 is a HD or a FD as an example of a detachable recording medium, and data is stored in the recording portion 1401 according to control of the respective drive devices. Also, the data is read from the recording portion 1401 according to the control of the respective drive devices.

The antenna 1402 conducts communication with the article tag T and the area tags Ta, Tb present in the communication range according to the control of the control portion 1403. The antenna 1402 reads the inventory area information and identification information through the communication with the article tag T and the area tags Ta, Tb and transmits the reading result to the DB server 1302 through the connection portion 1406.

The control portion 1403 governs control of the entire RFID reader 1301. Specifically, the control portion 1403 includes a CPU, a ROM, a RAM, and the ROM records various programs. Also, the RAM is used as a work area for the CPU. In detail, the control portion 1403 starts a control program of each component portion when the RFID reader 1301 is powered on and carries out control of each component portion. For example, the control portion 1403 controls the antenna 1402 so as to read the inventory area information and identification information from the article tag T and the area tags Ta, Tb.

The control portion 1403 executes output control of the display portion 1404 so that it displays the inventory result information and operation guide information. The control portion 1403 receives various input information from the input portion 1405 and controls the RFID reader 1301 on the basis of the received input information. The input portion 1405 includes a touch panel, operation buttons so that a user can make various inputs.

The DB server 1302 is provided with a DB 1411, a connection portion 1412, a control portion 1413, the display portion 1414, and an input portion 1415.

The DB 1411 is a recording medium such as a HD and FD, and data is recorded in the DB 1411 according to control of the respective drive devices. Also, the data is read from the DB 1411 according to the control of the respective drive devices.

In this DB 1411, various data including the above article lists are recorded. Specifically, in the DB 1411, various data shown in FIGS. 3 to 5 are recorded.

The connection portion 1412 receives information transmitted from the RFID reader 1301. Specifically, the connection portion 1412 receives the inventory area information and identification information of the articles A, B and executes writing in the DB 1411 according to the control of the control portion 1413.

The control portion 1413 determines whether or not the identification information of the articles A, B and the inventory area information received through connection portion 1412 match the registration identification information and storing area information in the article tables 300, 400 recorded in the DB 1411, respectively.

The control portion 1413 classifies the articles A, B into the inventory abnormal state if at least either the identification information and registration identification information or the inventory area information and storing area information do not match with each other. Specifically, for example, the control portion 1413 classifies the articles A, B for which identification information has not been read in the registration identification information into the undiscovered state. Also, the control portion 1413 classifies the articles A, B into the misplaced state if the inventory area information and storing area information do not match with each other for the articles A, B for which identification information and registration identification information match with each other. Also, the control portion 1413 classifies the articles A, B not in the registration identification information in the identification information read by the inventory into the unregistered state.

The control portion 1413 executes the return processing to the inventory normal state for the articles A, B classified into the inventory abnormal state. Specifically, the control portion 1413 executes reading of the article tag T on the basis of the articles A, B classified into the undiscovered state. That is, the control portion 1413 reads the article tag T of the articles A, B classified into the undiscovered state as search targets and updates the article table 400 on the basis of the reading result.

The control portion 1413 updates the article table 400 on the basis of the inventory area information of the articles A, B if the articles A, B are classified into the misplaced state. Specifically, the control portion 1413 changes the discovery place 304 in the article table 400 to the inventory area information for which the identification information of the articles A, B are read (an inventory is made) if the inventory area information for which the inventory is made for the articles A, B is different from the storing area information. Also, the control portion 203 may read the article tag T of the articles A, B as the search targets if the articles A, B are classified into the misplaced state and may notify the storing area information on the basis of the reading result. With this arrangement, the articles A, B having the inventory area information different from the storing area information can be searched and the articles A, B can be returned to an area where they should be contained.

The control portion 1413 executes the return processing on the basis of a comparison between the identification information of the articles A, B and the disposal table indicating the identification information of the disposed article if the articles A, B are classified into the unregistered state. Specifically, if the articles A, B classified into the unregistered state are present in the disposal table, it means that the articles A, B which should have been disposed of are still present, and the control portion 1413 prompts the user to dispose of the articles A, B. If the articles A, B classified into the unregistered state are not present in the disposal table, the control portion 1413 prompts the user to register the articles A, B in the article table 400.

The control portion 1413 executes output control of the display portion 1414 so that it notifies the inventory result information. Specifically, the inventory result information may be information indicating the inventory abnormal state classified by the control portion 1413. Also, the control portion 1413 gives the user notification relating to the return processing through the display portion 1414. The control portion 1413 receives various input information from the input portion 1415 and executes information transmission and reception with respect to the RFID reader 1301 and control of various operations on the basis of the received input information. The input portion 1415 includes a touch panel, operation buttons, for example, so that the user makes various inputs.

In the second embodiment 2 of the present invention, the case in which the articles A, B are classified into the inventory abnormal state is described, but if the identification information and registration identification information as well as the inventory area information and storing area information match with each other, respectively, it means the inventory normal state, and the fact that the inventory was normal is notified to the user without executing the return processing.

Explaining each component element and each function in association with each other, in the RFID reader 1301 shown in FIG. 13, by means of control of the antenna 1402 by the control portion 1403 shown in FIG. 14, functions of a radio communication portion and the area information obtainment portion according to the present invention are realized. Also, by means of the control of the connection portion 1406 by the control portion 1403, a function of a transmitting device according to the present invention is realized. Moreover, in the DB server 1302 shown in FIG. 13, by means of control of the connection portion 1412 by the control portion 1413, a receiving device according to the present invention is realized. Also, by means of the processing by the control portion 1413, functions of the determining portion and the classifying portion according to the present invention are realized. Also, by means of control of the display portion 1414 by the control portion 1413, the function of the display device according to the present invention is realized. Also, by means of control of the connection portion 1412 and the display portion 1414 by the control portion 1413, the function of the return processing portion according to the present invention is realized.

(Outline of the Processing of the Article Inventory System 1300)

Here, contents of the processing of the article inventory system 1300 according to the second embodiment of the present invention will be described. Since the outline of the data of the article inventory system and the outline of the display of the inventory result information according to the second embodiment of the present invention are substantially the same as those in the first embodiment, description thereof will be omitted. Also, since the outline of the processing according to the second embodiment of the present invention is substantially the same as those in FIGS. 6 to 12 shown in the first embodiment, particularly different processing will be described using FIGS. 6 to 12. Specifically, the second embodiment of the present invention is configured to execute the processing of the RFID reader 101 in the first embodiment by the RFID reader 1301 and the DB server 1302.

Step S601 shown in FIG. 6 is the processing executed by the RFID reader 1301 and the DB server 1302. Step S602 shown in FIG. 6 is the processing executed by the RFID reader 1301 and the DB server 1302. Specifically, the ID of the article tag T affixed to the articles A, B in the inventory area is read by the RFID reader 1301 (Step S701 shown in FIG. 7). Then, the RFID reader 1301 transmits the read ID to the DB server 1302. The DB server 1302 executes the processing at Step S702 and after using the ID transmitted from the RFID reader 1301.

Step S603 shown in FIG. 6 is the processing executed by the DB server 1302. Specifically, the DB server 1302 executes the display processing of the inventory result shown in FIG. 8. In the second embodiment of the present invention, it is configured to display the inventory result on the display portion 1414 at Step S812, but it may be so configured to transmit the inventory result to the RFID reader 1301 so as to display the inventory result on the display portion 1404.

Step S604 and Step S605 shown in FIG. 6 is the processing executed by the DB server 1302. Specifically, the selection of the return processing is executed by displaying the inventory result display screen 900 shown in FIG. 9 by the display processing at Step S603 on the basis of the processing selection buttons 921, 931, 932, 933 and 941 selected by the user.

Step S606, Step S607 and Step S608 shown in FIG. 6 are the processing executed by the RFID reader 1301 and the DB server 1302. Specifically, by the RFID reader 1301, the user is prompted for the search processing (Step S1001 shown in FIG. 10, Steps S1101 and S1102 shown in FIG. 11, and Step S1201 shown in FIG. 12).

The DB server 1302 outputs the search instruction to the RFID reader 1301 on the basis of the selection of the processing selection buttons 921, 931, 932, 933 and 941. The RFID reader 1301 executes the search processing of the article according to the search instruction from the DB server 1302 (Steps S1002 and S1003 shown in FIG. 10, Step S1103 shown in FIG. 11, and Step S1202 shown in FIG. 12) and outputs the search result to the DB server 1302. Then, the DB server 1302 executes the subsequent processing on the basis of the search result output from the RFID reader 1301.

As described above, according to the article inventory system according to the second embodiment of the present invention, the article contained state can be kept normal by having the user take an appropriate measure for the articles classified into the inventory abnormal state. Particularly, the second embodiment of the present invention is configured such that the DB server executes each processing of determination relating to the inventory, classification of the inventory state, return to the inventory normal state, and therefore the configuration of the RFID reader can be simplified. Also, since the DB server can be configured by a PC, general-purpose properties of the article inventory system can be improved.

(Variations of Other Functions)

In the second embodiment of the present invention, various notifications are made by the display portion 1414 at Step S1004, Step S1011, Step S1105, Step S1106 and Step S1204, but it may be so configured that a notification is made by the display portion 1404 of the RFID reader 1301. In this case, the information to notify is transmitted from the DB server 1302 to the RFID reader 1301 before Step S1004, Step S1011, Step S1105, Step S1106 and Step S1204. With this arrangement, the user can check the notified information only by checking the display portion 1404 of the RFID reader 1301 without checking the display portion 1414 of the DB server 1302 each time.

Particularly in the second embodiment of the present invention, as an example of the processing of the area information obtainment portion, the case in which the inventory area information of the area tag is read at Step S701 shown in FIG. 6 is described, but not limited to that. Specifically, by employing a configuration provided with position calculating portion such as Global Positioning System (GPS) in the RFID reader, for example, the area information for making an inventory can be obtained. In this case, the transmitting device and receiving device may be configured differently according to the type of the inventory area information and identification information of the inventory articles. With this arrangement, an inventory can be made without providing an area tag in the inventory area.

What is claimed is:

1. An article inventory device configured to make an inventory of an article by reading identification information of said article via radio communication from a radio frequency identification (RFID) tag, said RFID tag being affixed to said article as a target of the inventory and recording said identification information of said article, comprising:
an area information obtainment portion configured to obtain inventory area information at said inventory;
a recording portion configured to record an article list in which registration identification information of said article registered in advance and storing area information are associated with each other;
a determining portion configured to determine whether or not said registration identification information in said article list recorded by said recording portion match the identification information of said article and whether or not said storing area information in said article list recorded by said recording portion match said inventory area information obtained by said area information obtainment portion;
a classifying portion configured to classify said article into a group of an inventory abnormal state if it is determined by said determining portion that at least either said identification information and said registration identification information or said inventory area information and said storing area information do not match; and
a return processing portion configured to execute return processing to an inventory normal state for said article classified into said group of the inventory abnormal state by said classifying portion.

2. The article inventory device according to claim 1, wherein:
said classifying portion classifies said article corresponding to specified registration identification information among said registration identification information recorded in said article list into a group of an undiscovered state, said specified identification information has not been read; and
said return processing portion reads said RFID tag with respect to said article classified into said group of the undiscovered state by said classifying portion and updates said article list on the basis of a reading result.

3. The article inventory device according to claim 2, wherein:
said classifying portion classifies the state of said article for which said identification information has not been read into said group of the undiscovered state when said inventory for at least one region among predetermined regions divided from said inventory area is performed; and
said return processing portion reads said RFID tag of said article as a search target, said article classified into said group of the undiscovered state by said classifying portion.

4. The article inventory device according to claim 1, wherein:
said classifying portion classifies said article for which said identification information and said registration identification information match with each other into a group of a misplaced state if said inventory area information and said storing area information do not match with each other; and
said return processing portion updates said article list on the basis of said inventory area information obtained by said area information obtainment portion.

5. The article inventory device according to claim 1, wherein:
said classifying portion classifies said article for which said identification information and said registration identification information match with each other into a group of a misplaced state if said inventory area information and said storing area information do not match with each other; and
said return processing portion reads said RFID tag of said article as a search target and notifies said storing area information on the basis of a result of the reading, said article classified into said group of the misplaced state by said classifying portion.

6. The article inventory device according to claim 1, wherein:
said classifying portion classifies said article corresponding to specified identification information read at said inventory into a group of an unregistered state, said specified identification information not included in said registration identification information; and
said return processing portion executes said return processing on the basis of result of comparison between the identification information of said article classified by said classifying portion into said group of the unregistered state with a content of a disposal list indicating the identification information of a disposed article, deleted from said article list.

7. The article inventory device according to claim 1, further comprising a display device configured to display inventory result information indicating said inventory abnormal state on the basis of a classification result by said classifying portion; wherein:
said return processing portion notifies a user of a content of said return processing on the basis of said inventory result information displayed by said display device.

8. An article inventory system comprising:
a radio frequency identification (RFID) tag being affixed to an article as a target of an inventory and recording identification information of said article;
an apparatus for communicating with an RFID tag configured to communicate with said RFID tag; and
a server having a database configured to record an article list in which registration identification information of said article registered in advance and storing area information are associated with each other,
said apparatus for communicating with an RFID tag including:
a radio communication device configured to read said identification information of said article;
an area information obtainment portion configured to obtain inventory area information at said inventory; and
a transmitting device configured to transmit said identification information of said article read by said radio communication device and said inventory area information obtained by said area information obtainment portion to said server; and
said server including:
a receiving device configured to receive said identification information of said article transmitted and said inventory area information by said transmitting device;
a determining portion configured to determine whether or not said registration identification information in said article list match said identification information of said article received by said receiving device and whether or not said storing area information in said article list match said inventory area information received by said receiving device;
a classifying portion configured to classify said article into a group of an inventory abnormal state if it is determined by said determining portion that at least either said identification information and said registration identification information or said inventory area information and said storing area information do not match; and
a return processing portion configured to execute return processing to an inventory normal state for said article classified into said group of the inventory abnormal state by said classifying portion.

9. The article inventory system according to claim 8, wherein:
said return processing portion outputs a search instruction to said apparatus for communicating with an RFID tag with respect to said article as a search target, said article being classified into said group of the inventory abnormal state;
said apparatus for communicating with an RFID tag executes search processing of said article on the basis of said search instruction and outputs a result of said search processing to said server; and
said return processing portion updates said article list on the basis of a result of said search processing.

10. An article inventory method in which an inventory of an article is made by using identification information of said article read via radio communication from an RFID tag being affixed to said article as a target of the inventory and recording said identification information of said article and using an article list in which registration identification information and storing area information of said article registered in advance are associated with each other, comprising the steps of:
a radio communication step for reading the identification information of said article via said radio communication;
an area information obtainment step for obtaining inventory area information at said inventory;
a determination step for determining whether or not said registration identification information in said article list match said identification information of said article read in said radio communication step and whether or not said storing area information in said article list match said inventory area information obtained in said area information obtainment step;
a classification step for classifying said article into a group of an inventory abnormal state if it is determined that at least either said identification information and said registration identification information or said inventory area information and said storing area information do not match in said determination step; and
a return processing step for executing return processing to an inventory normal state for said article classified into said group of the inventory abnormal state in said classification step.
